(19) United States
(12) Patent Application Publication
(10) Pub. No.: US 2018/0128780 A1
(43) Pub. Date: May 10, 2018

(54) Method and Apparatus for Inspecting Cracks in Threaded Holes

(71) Applicant: Caterpillar Inc., Peoria, IL (US)

(72) Inventors: Christopher Anthony Kinney, Iuka, MS (US); Kegan Luick, Corinth, MS (US)

(73) Assignee: Caterpillar Inc., Peoria, IL (US)

(21) Appl. No.: 15/347,028

(22) Filed: Nov. 9, 2016

(51) Int. Cl. G01N 27/87; G01M 15/04

(52) U.S. Cl. CPC G01N 27/87; G01M 15/042

(57) ABSTRACT

A method for inspecting for discontinuities in a hole comprises inserting a probe including a first location having a first magnetic plarity and a second location having a second polarity into the hole, wherein the first location and second location have different magnetic polarities, creating a magnetic field between the first location and the second location within the interior of the hole, and detecting a discontinuity in the hole using the magnetic field.

### TECHNICAL FIELD

The present disclosure relates to inspection techniques for finding cracks or other discontinuities in threaded holes. Specifically, the present disclosure relates to a method and apparatus for inspecting cracks or other discontinuities in threaded holes using a specially tailored inspection probe.

### BACKGROUND

Connecting rods are routinely used in the industry to attach a crank shaft to a reciprocating piston in combustion engines and the like. FIG. 1 illustrates such a connecting rod 100 that may experience cracks or other discontinuities in the blind threaded hole that is used to connect the two parts, often referred to as the main rod portion 102 and the cap portion 104, of the connecting rod 100 together. A bolt 106 is inserted into the counterbore 110 of the cap portion 104 and threaded into the blind threaded hole (not shown in FIG. 1). Two such bolted connections 108 are shown on either side of the connecting rod 100. Other configurations exist but usually have a blind hole on one part of the connecting rod and a counterbore on the other part.

FIG. 2 shows half 102′ of such a blind threaded hole 112, which was cut from the main rod portion 102 of a connecting rod 100 using an EDM process. Cracks or other discontinuities may develop at the root 116 of the internal threads 114. If such discontinuities are not detected at various maintenance intervals, the discontinuity may result in downtime for an engine and any associated machine or apparatus, which can be quite costly. As illustrated by FIG. 2, certain areas are historically associated with fatigue cracks and the like. For example, the intersection 118 of where the bottom 120 of the hole 112 meets or intersects the sidewall 122 may susceptible to such cracks. As shown, the bottom 120 of the hole 112 has a ball nose shape but drill point shapes are also sometimes employed in these type of blind threaded holes. Next, the bottom four roots 124 of the internal threads 114 sometimes exhibit stress cracking over time. Finally, the rest of the roots 126 of the internal threads 114 found further away from the bottom 120 of the hole 112 may occasionally exhibit signs of stress. The depth D of the hole 112 may be two inches or more, making inspection difficult of these areas difficult.

In particular, connecting rod bolt holes may exhibit cracking in rolled internal threads due to overload and/or fatigue. All methods of current non-destructive testing to date have not been able to identify and discern the presence of cracks or other discontinuities in the root of the threads compared to surface condition of the rolled pitch. Accordingly, it is desirable to be better able to inspect the core material for these defects or discontinuities and remove connecting rods or components thereof from an engine or associated machine/apparatus to avoid costs before servicing is required.

U.S. Pat. No. 6,175,234 to Granger Jr. et al. discloses a self-aligning eddy current probe and associated holder for detecting discontinuities in blind holes. However, the probe is not well suited for finding cracks at the root of threads of an internally threaded hole. More specifically, the probe is not well suited for detecting cracks or other discontinuities associated with rolled threads.

Looking at FIG. 3, one of the challenges associated with using magnetic particle inspection on rolled threads 128 may be understood. Rolled threads 128 are often used in high stress applications due to the geometry of the root 130 produced when rolling threads since rolling is a material deforming process rather than a cutting process. As can be seen, the roots 130 of the threads 128 have curves such as radii 132 that reduce stress, leading to a longer useful life for the bolted joint. However, the free ends or pitches 134 of the threads 128 form cavities 136. The reason for this can be understood by looking at the material deformation, represented by curves 138, which takes place during the rolling process. As material is pushed down to make the roots 130, the tips or pitches 134 of the threads 128 experience a loss of material that creates these voids 136.

Magnetic particle inspection requires that the area to be inspected be magnetized. Any cracks or other discontinuities create a leakage of the magnetic flux. Consequently, the magnetic particles are attracted to these areas and stay there while the part is magnetized. UV light may cause these particles to fluoresce so that they can be visually discernible. However, other natural occurring part changes such as voids associated with the pitches or peaks of the rolled internal threads will also accumulate these magnetic particles. As can be imagined, threads are tightly spaced and it can be difficult to determine an actual discontinuity versus normal part geometrical variation, possibly resulting in a false positive for a defect.

For all the above reasons, a need exists for a method and apparatus for detecting or inspecting cracks in blind threaded holes that may use magnetic particle inspection with increased precision and accuracy.

### SUMMARY

A probe for detecting discontinuities at the roots of internal threads is provided. The probe comprises an elongated probe portion that defines a longitudinal axis, a radial direction, a circumferential direction and a circumferential surface, wherein the circumferential surface defines an external thread profile including at least a first pitch, and wherein the first pitch defines a first magnetic polarity and a second magnetic polarity that is different than the first magnetic polarity.

A probe for detecting discontinuities at the bottom of a hole is provided, the probe comprises an elongated probe portion that defines a longitudinal axis, a radial direction, a circumferential direction and a circumferential surface, wherein the elongated probe portion further defines a free end that intersects with the circumferential surface and wherein the elongated portion includes a first location on the free end adjacent the intersection along the longitudinal axis and a second location on the circumferential surface adjacent the intersection along the longitudinal axis, and wherein the first location defines a first magnetic polarity and the second location defines a second magnetic polarity that is different than the first magnetic polarity.

A method for inspecting for discontinuities in a blind hole is provided. The method comprises inserting a probe including a first location and a second location into the hole of a component to be inspected, creating a magnetic field between the first location and the second location within the interior of the hole, and detecting a discontinuity in the hole using the magnetic field.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a perspective view of a connecting rod comprising two parts, often called the main rod portion and the cap portion, which are attached to each other via a threaded connection including a bolt that is threaded into a blind threaded hole as is known in the art.

FIG. 2 is a fragment containing the blind threaded hole taken from main rod portion of FIG. 1.

FIG. 3 is an enlarged cross-sectional view of the threads of the hole of FIG. 2, showing the configuration of rolled threads that define a cavity at the tips or pitches of the threads.

FIG. 4 is cross-sectional view of a probe according to an embodiment of the present disclosure that is inserted into a blind threaded hole, having areas of different magnetic polarity disposed on either side of points in the blind threaded hole prone to fatigue or stress cracks.

FIG. 5 is a cross-sectional view of a probe according to another embodiment of the present disclosure that uses fewer areas of different magnetic polarity as compared to the probe of FIG. 4.

FIG. 6 is a cross-section view of a probe according to yet another embodiment of the present disclosure that employs a threaded profile and radially extending holes to supply magnetic particles to regions prone to fatigue or stress cracks.

FIGS. 7 and 8 illustrate another embodiment of a probe where the threaded portion is divided into movable parts that can engage and disengage the threads of the blind hole. FIG. 7 shows the movable parts in the disengaged configuration while FIG. 8 shows the movable parts in the engaged configuration.

FIG. 9 shows an embodiment of a probe that uses a plurality of movable yokes to create a magnetic field through a desired area of inspection of the blind hole.

FIG. 10 depicts an embodiment of a current conducting probe that creates a magnetic field along the most the depth of the blind hole.

FIG. 11 shows an inspection tool that may be threaded into a blind hole for visually scanning the root of the internal threads of the hole for discontinuities or cracks.

FIG. 12 is a flowchart showing a method of using the apparatus according to various embodiments of the present disclosure.

FIG. 13 is a flowchart showing a more general method of using an apparatus according to various embodiments of the present disclosure.

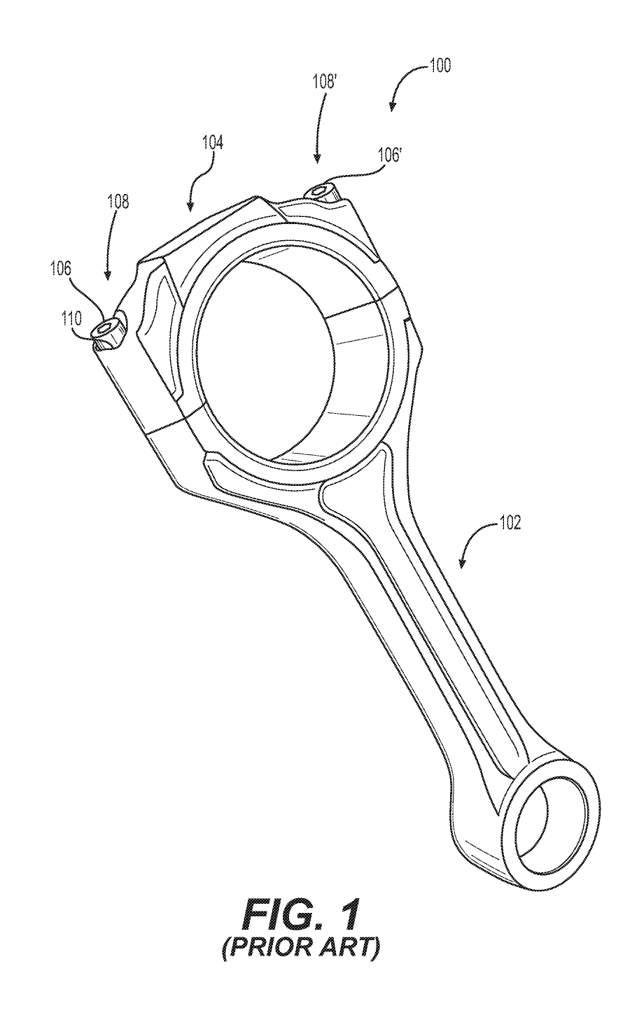

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a , 100b or a prime for example 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, which have identical or similar functions or geometry, discussed within this written specification.

The inventors of the present disclosure have determined that it is most important to be able to find discontinuities associated with the intersection of the bottom of the threaded hole with the sidewall and the bottom four roots. Accordingly, various embodiments of the present disclosure include a probe that is configured to create a magnetic field inside of the hole so that magnetic particles of a magnetic containing fluid or solution may be attracted to discontinuities that can later be identified. In particular, some embodiments allow a customization and a precision not before possible in the art by creating localized magnetic fields associated with a particular root or intersection that is to be inspected. Also, the probe may be outfitted with a camera or may be removed to allow the insertion of a camera and a light source so that the accumulation of magnetic particles may be seen, identifying discontinuities. Areas where false positives are a concern may substantially lack a magnetic field in some embodiments, reducing the unwanted accumulation of magnetic particles in those areas.

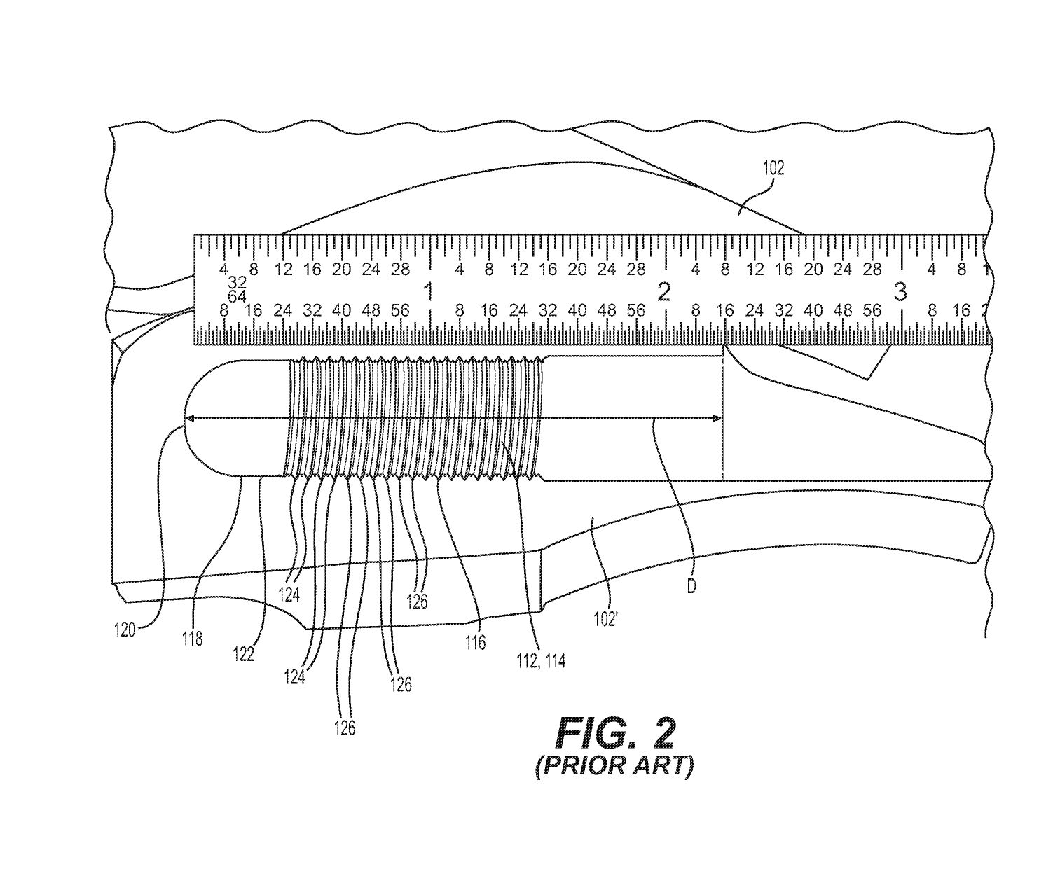

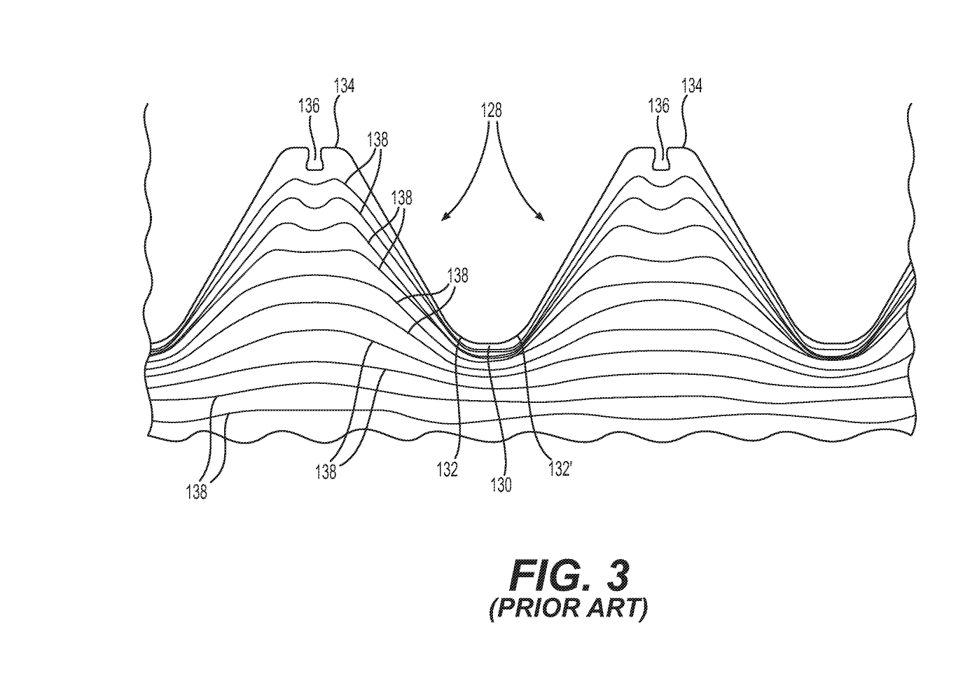

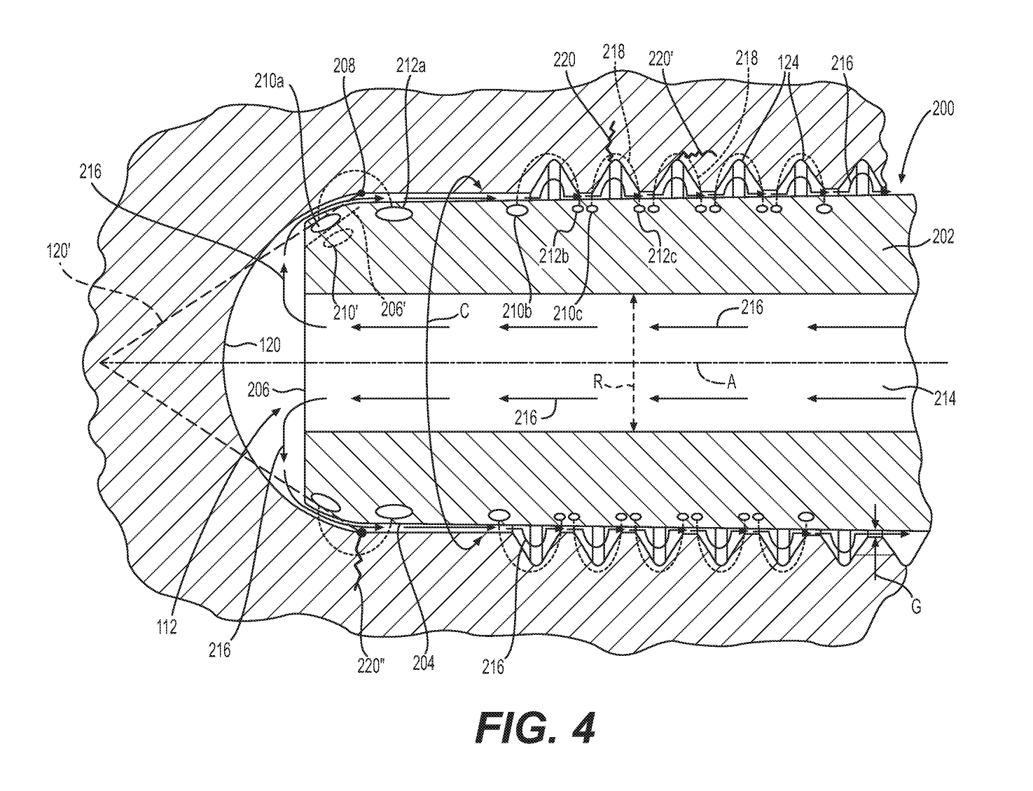

FIG. 4 shows a first embodiment of a probe 200 according to the present disclosure for use with magnetic particle inspection. The internally threaded blind hole 112 defines a bottom surface 120 with a ball nose shape similar to what has been discussed previously with reference to FIG. 2. An alternate drill point shape is possible and is illustrated by dotted lines 120′.

The probe 200 may be used for detecting discontinuities at the bottom portion of the blind hole 112. The probe 200 comprise an elongated probe portion 202 that defines a longitudinal axis A, a radial direction R, a circumferential direction C and a circumferential surface 204. The elongated probe portion 202 further defines a free end 206 that intersects (see point 208) with the circumferential surface 204. The elongated probe portion 202 may also have a generally annular shape. The free end 206 may approach but not touch the bottom surface 120 of the hole 112. This creates a gap G between the probe 200 and the surfaces of the hole 112 about the entire perimeter of the hole. This gap G may be maintained using a precision alignment and depth measurement system. Alternatively, discrete stop members (not shown) may impinge on the bottom surface of the hole, preserving areas of a gap between the free end of the probe and the bottom surface of the hole.

As shown in FIG. 4, the elongated probe portion 202 may include a first location 210 on the free end 206 adjacent the intersection 208 along the longitudinal axis A and a second location 212 on the circumferential surface 204 adjacent the intersection 208 along the longitudinal axis A. The first location 210 defines a first magnetic polarity and the second location 212 defines a second magnetic polarity that is different than the first magnetic polarity. For this embodiment, the circumferential surface 204 lacks a threaded profile.

Due to the annular shape of the probe 200, the elongated probe portion 202 is at least partially hollow, defining an internal void or central flow path 214 through which the magnetic particle solution may flow under pressure (see arrows 216) toward the bottom 120 of the hole 112. The solution may then flow upwards in the annular gap G maintained between the circumference 204 of the probe 200 and the surfaces of the hole 112. Thus, as the critical areas are magnetized (see magnetic field line 218), any discontinuity 220 will accumulate magnetic particles that may later be seen. Discontinuity 220 is better oriented to be detected by this probe than discontinuity 220′ since it is more perpendicular to the magnetic field line 218. Adjustment to the magnetic field line may be made to better detect various orientations of discontinuities as will be discussed in further detail later herein.

For this embodiment, each of the bottom four to five roots 124 are magnetized by a plurality of first and second locations 210, 212 that have a different polarity. For the example, the first location may have a north polarity and the second location may have a south polarity, or vice versa. The probe and these specifically placed areas of different magnetic polarity may be manufactured using 3D magnet printing techniques. This provides a fairly localized magnetic field so that magnetic particle accumulation and detection may be improved as compared to the prior art. In some embodiments, a relatively thin sheet of 3D magnets may be formed using a 3D printing process which is then adhered to a base layer. Any of the magnetics discussed herein may be fabricated in this manner.

It is contemplated that the flow of the magnetic particles could be reversed if a negative pressure was applied to the central flow path 214, creating a suction flow. The free end 206 of the probe 200 may complimentarily shaped to match that of the bottom surface 120 of the hole 112. Hence, the shape of the free end 206 could be ball nose shaped, angled to match a drill point shape of the hole, etc. Dotted lines 206′ and 210′ represent such an alternate configuration of the free end and the first location having a first magnetic polarity.

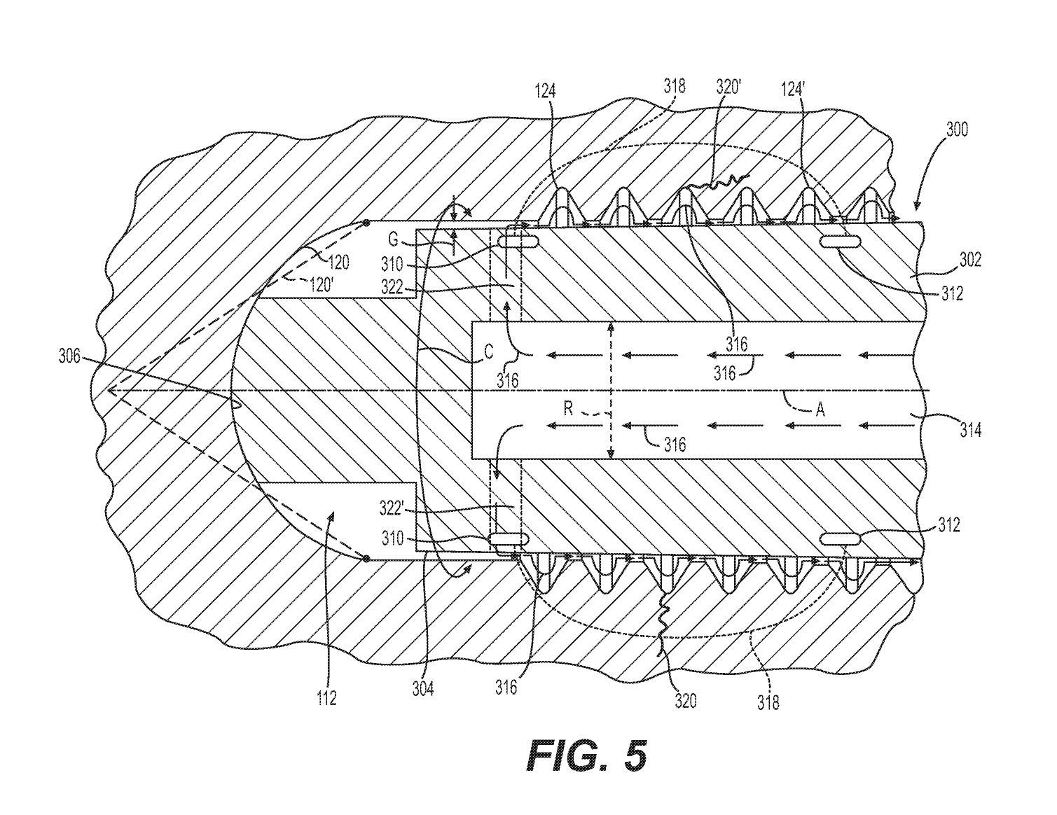

FIG. 5 shows a probe 300 that is similarly constructed and used as the probe 200 of FIG. 4 except for the following differences. First, the free end 306 of the elongated probe portion 302 is designed to contact the bottom surface 120 of the hole 112, helping to ensure the alignment of the first and second locations 310, 312 having different magnetic polarities disposed along the circumferential surface 304 of the probe 300 are properly aligned with the desired region to be inspected. No magnetic locations are provided to inspect the intersection 118 of the sidewall 122 and bottom surface 120 of the hole 112 in this embodiment. Instead only one magnetic field (see line 318) is created between the first location 310, which is deeper along the longitudinal axis A than the bottommost root 124 of the internal threads of the hole 112, and the second location 312, which is further away from the bottom surface 120 of the hole 112 than the fifth root 124′ as measured along the longitudinal axis A. Consequently, a less localized magnetic field is created, making early detection of discontinuities 320 harder. Also, discontinuities 320′ oriented parallel to the longitudinal axis A may go undetected. However, it is contemplated that this embodiment may be suitable for certain applications.

Second, the central flow path 314 is blind and communicates with a plurality of radially extending bores 322 that provide fluid communication with the gap G between the circumference 304 of the probe 300 and the surfaces of the hole 112. Again, pressurization may cause the magnetic particle fluid to flow (see arrows 316) towards the bottom of the central flow passage 314, through the radially extending bores 322, and up the annular gap G so that discontinuities can accumulate magnetic particles, leading to detection of the discontinuity later on.

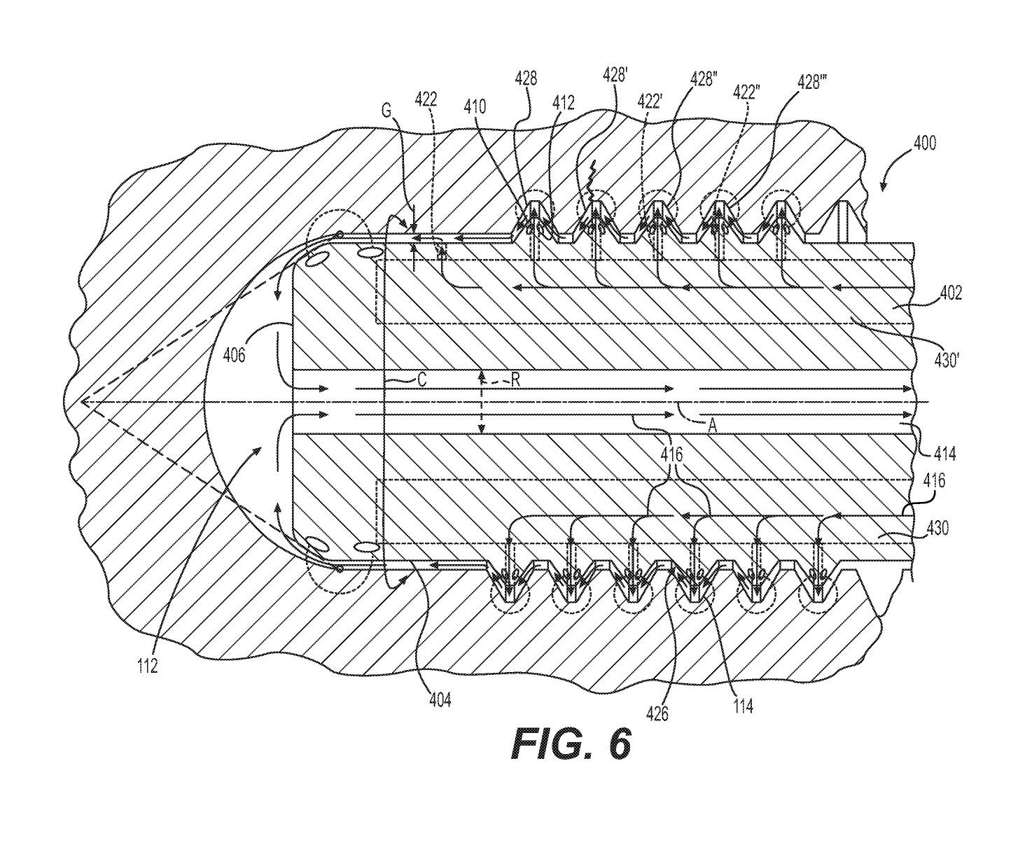

FIG. 6 illustrates a more complex and customizable embodiment of a probe. For this embodiment, the probe 400 comprises an elongated probe portion 402 that defines a longitudinal axis A, a radial direction R, a circumferential direction C and a circumferential surface 404. The circumferential surface 404 defines an external thread profile 426 including at least a first pitch 428. The first pitch 428 defines a first magnetic polarity 410 and a second magnetic polarity 412 that is different the first magnetic polarity. The probe may comprise a plurality of similarly configured pitches 428 having first and second magnetic polarities 410, 412 that are different from each other. For example, the first magnetic polarity may be north and the second magnetic polarity may be south.

In some cases, the external thread profile 426 is a standard thread profile but may be a non-standard thread profile in other embodiments. In particular applications, the thread profile may be a 9/16″-18 2B rolled thread profile but other sizes and tapped threads are also within the scope of the present disclosure. In FIG. 6, clearance is provided on the male threads 426 of the probe 400 so that gap G is maintained and binding with the internal threads 114 of the hole 112 is avoided. As a result, there may be some play between the threads of the probe and the threads of the hole depending on various manufacturing tolerances of the hole and the probe.

Again, the elongated probe portion 402 defines an internal void, making the probe portion at least partially hollow. In this embodiment, the internal void takes the form of a central flow path 414 and extends to the free end 406 of the probe 400. In this embodiment, two inlet channels 430 and a single central outlet channel 414 are provided. The elongated probe portion 402 defines a plurality of small bores or apertures 422 extending at least partially radially from the inlet channels 430 to the annular gap G through the threaded profile 426 of the circumferential surface 404. This allows flow (see arrows 416) to occur from the outside toward the inside of the hole 112 and back out the outlet channel 414. This flow could be reversed if so desired.

This configuration of a probe 400 may be built using 3D magnet printing technology. Small bores 422 may be machined using an EDM process. By placing the magnets into the threads, a more localized magnetic field is created (see magnetic field lines 418) that may increase the accuracy and precision for detecting discontinuities 420 even further.

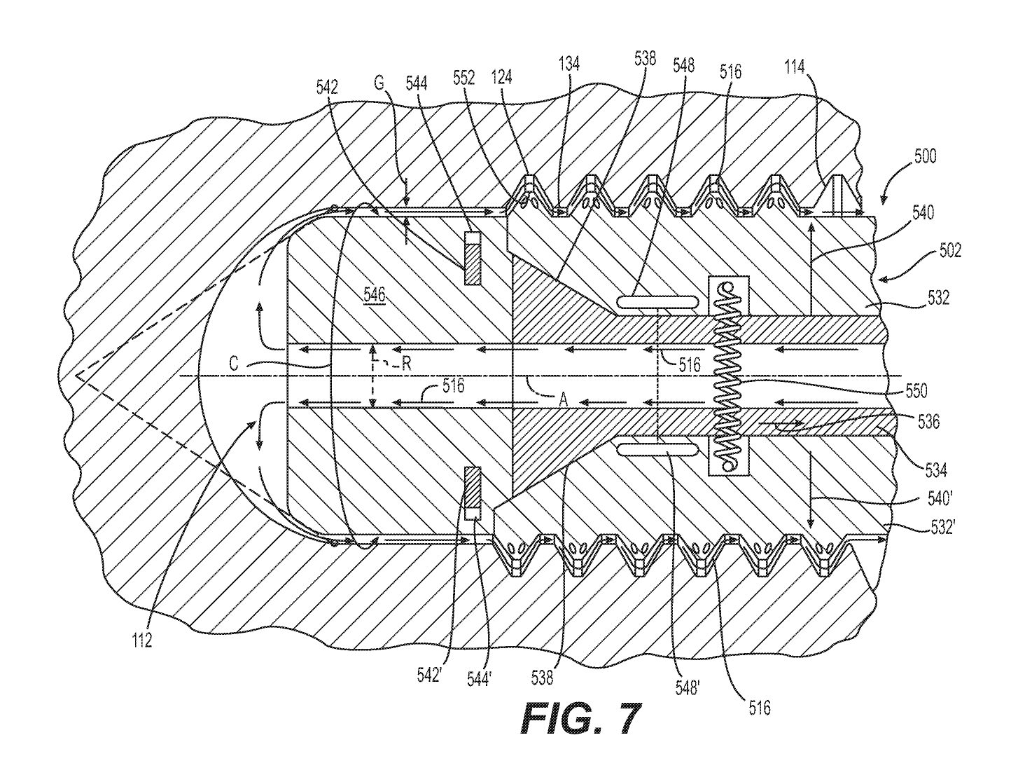

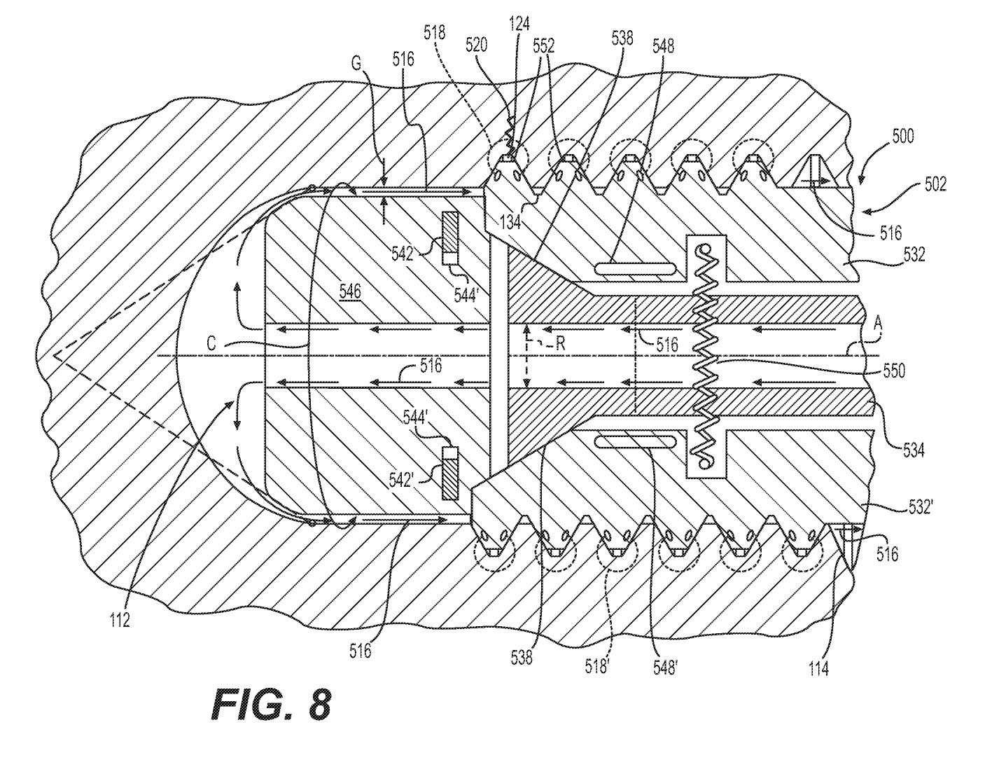

FIGS. 7 and 8 provide yet another embodiment of a probe 500 having even greater complexity than the probe 400 of FIG. 6. In some applications, it may be desirable to fully insert the magnets into the threads until contact is made to maximize accuracy and to minimize the amount of magnetism exhibited at the free ends of the rolled threads that may have cavities or voids in them for reasons discussed earlier herein.

To that end, the probe 500 of FIGS. 7 and 8 has an elongated probe portion 502 that includes movable threaded pieces 532 that are biased into a retracted position allowing the probe 500 to be threaded into the hole 112 with little to no binding. Then, a draw member 534 with a threaded portion (not shown) and which is slotted and keyed, preventing rotation of the draw member, may be mated with another threaded member, which when rotated, pulls on the draw member, moving the draw member 534 to the right in FIG. 7 (see arrow 536). This causes the cam surface 538 of the draw member 534 to force the movable threaded pieces 532 outward (see arrow 540) until they engage the threads 114 of the hole 112 (see FIG. 8). This provides for a magnetic field (see magnetic field line 518 in FIG. 8) that is as localized as possible, increasing local detection of discontinuities 520 at the root 124 while avoiding or at least minimizing the attraction of magnetic particles at the tips 134 of the threads 114 of the hole 112.

Movement of the threaded pieces 532 may be provided by a key 542 in slot 544 arrangement where the key 542 is part of the movable threaded piece 532 and the slot 544 is part of the main member 546 of the probe 500. The force biasing the movable threaded pieces 532 into the retracted position may be provided using attractive magnets 548, an extension spring 550, a solenoid (not shown), etc.

Before the threaded pieces 532 have engaged the threads 114 of the hole 112, the flow (see arrows 516 in FIG. 7) of the magnetic particle solution may flow as described in FIG. 4. Once the threaded pieces 532 have engaged the threads 114 of the hole 112, the magnetic particle solution may flow (see arrows 516 in FIG. 8) in a manner similar to that described with reference to FIG. 4 except for the following difference. A consistent gap G between the probe 500 and the surfaces of the hole 112 is no longer provided past the threaded pieces 532 along the cylindrical axis A. Instead, gaps formed circumferentially between the movable pieces 532 and between the free tip 552 of the threads 526 of the movable pieces 532 and the root 124 of the internal threads 114 provide axial and circumferential flow, allowing the solution to eventually exit out of the hole along its threaded perimeter. Alternatively, tiny holes may be provided that direct the magnetic particle solution to the roots individually.

In some embodiments, two movable threaded pieces spanning less than 180 degrees individually about the circumference of the hole may be employed. In other embodiments, four movable threaded pieces spanning less than 90 degrees individually about the circumference of the hole may be employed. Other configurations are possible. A sliding attachment is shown for these movable threaded pieces, but it is contemplated a hinged connection may be used in other embodiments.

Once a suitable time has elapsed to allow the accumulation of the magnetic particles, the probe may be removed by reversing the assembly process just described. Thus far, probes using DC magnets created using 3D magnet printing technology have been discussed. It should be noted that any of the features for any of the embodiments discussed thus far may be used in other of the embodiments discussed thus far to yield further embodiments. Two other embodiments of probes using different techniques will now be described.

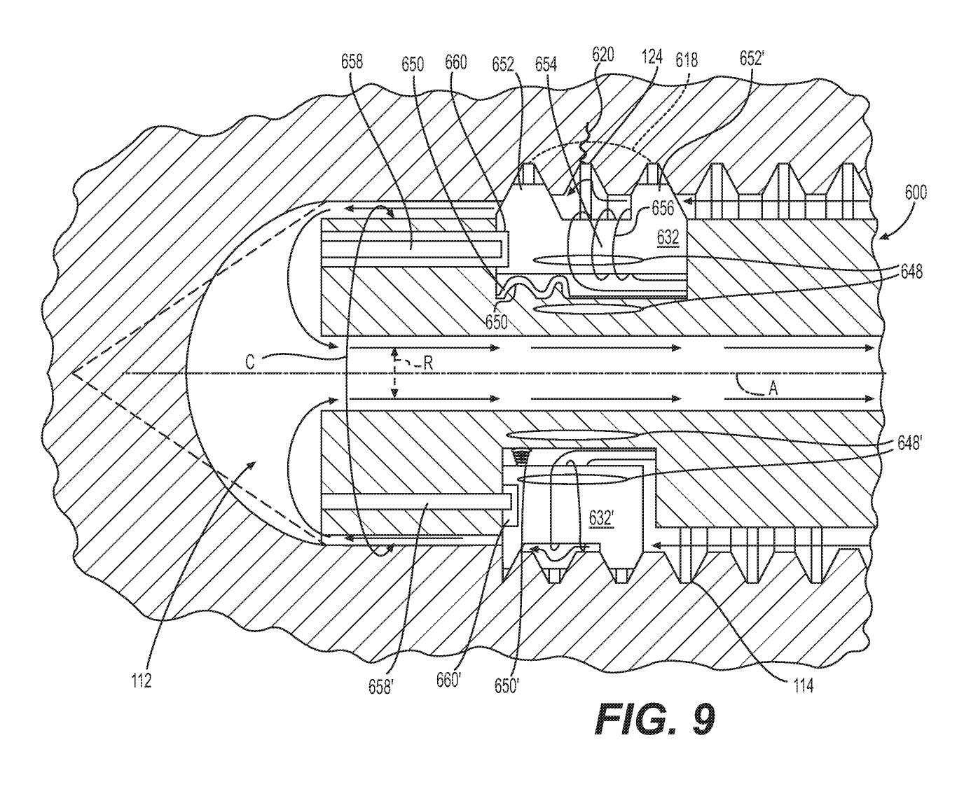

Looking now at FIG. 9, an embodiment of a probe 600 using movable threaded members 632 that act as magnetic yokes is shown. The top instance of the movable threaded member 632 includes two spaced apart pitches 652 with a bridge portion 654 connecting them together. A coil 656 conveying current is wrapped around this bridge 654, causing the two spaced apart pitches 652 to create a magnetic field 618 that helps detect a discontinuity 620 located in the root 124 between the two spaced apart pitches 652. The current may be a DC current, AC current or a pulsating DC current. The movable threaded member 632 may be held in place by a pin 658 that is inserted into a pocket 660 on the side of the movable threaded member 632, allowing some radial and circumferential play. A disc spring 650 or repulsive magnets 648, etc. may provide a biasing force that encourages the movable threaded member 632 to contact the threads 114 of the hole 112 in a yieldable manner. Hence, binding of the probe as it is threaded into the hole may be avoided.

The bottom instance of the movable threaded member 632′ also acts as a magnetic yoke in a similar manner as the top instance. It is biased into engagement with the internal threads of the hole via a compression spring 650′ or magnets 648′, etc. It too is held into place by a pin 658′ that is inserted into a pocket 660′ on its side that allows some radial and circumferential play. Accordingly, the movable threaded member 632′ will contact the internal threads of the hole without causing binding.

The spatial relationship between the movable threaded members 632, 632′ and the hole may be the same as that discussed above with regards to FIG. 8. Accordingly, the same flow path for magnetic particle solution is provided except the flow is shown reversed for this embodiment as compared to FIG. 8.

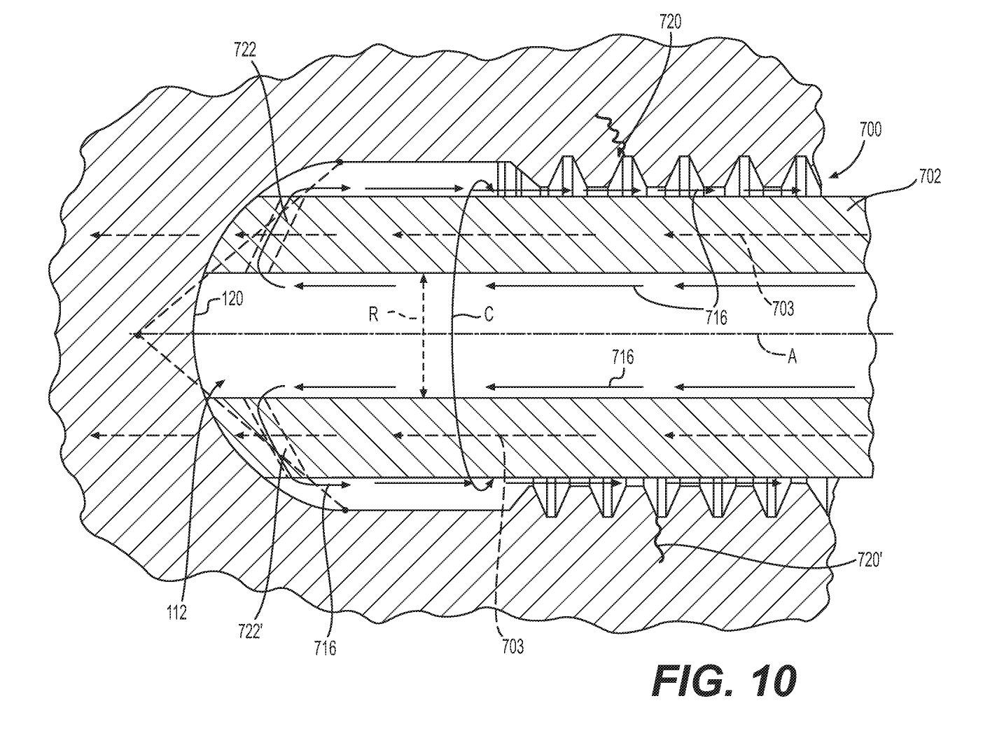

FIG. 10 depicts an embodiment of a probe 700 that acts a current conductor. More specifically, the elongated probe portion 702 contacts the bottom 120 of the hole 112, allowing current to flow (see arrows 703) through the probe into the part defining the hole. This creates a magnetic field entering the page at the top of the figure and exiting the page at the bottom of the figure using the right hand rule. This means that detecting a discontinuity 720 running parallel to the axial direction is easier for this probe 700 than a discontinuity 720′ running in the radial direction. Radially extending bores 722 are provided to allow flow of the magnetic particle solution (see arrows 716) similar to what was discussed for FIG. 5.

It is contemplated that multiple orientations of magnets or magnet inducing devices may be employed with any of the embodiments discussed herein, increasing the likelihood that a discontinuity of any orientation may be detected. For example, when using 3D magnet printing technology, the orientation of the magnets along the pitch of the thread may be varied about the circumference of the probe. In such a case, rotation of the probe may allow these differently oriented magnetic devices to successfully magnetize any discontinuities regardless of their orientation such that magnetic particles will collect there in a sufficient volume to be detected.

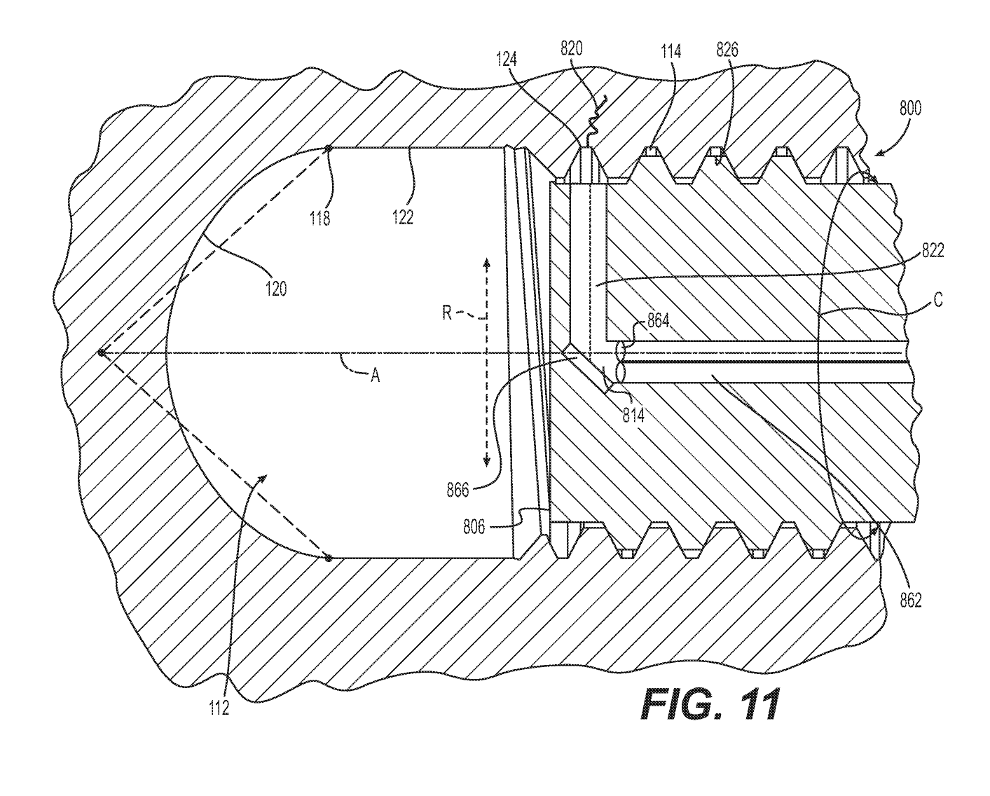

Once the magnetic particles have been sufficiently dispersed and accumulated, it is desirable to see them using a UV light source, which causes them to fluoresce. FIG. 11 illustrates a detection device 800 that may be used to find discontinuities 820 indicated by the collection of magnetic particles in areas difficult to reach or see. The detection device 800 includes a central bore 814 that is in communication with a radial bore 822 that is aligned with the root 124 of an internal thread 114. A camera 862 and a UV light source 864 may be designed to observe the root either directly, or as shown in FIG. 11, indirectly using a mirror 866. The timing and configuration of the threads 826 of the detection device 800 to the radial bore 822 is such that when the threads 826 of the detection device 800 are properly mated with the threads 114 of the hole 112, rotation of the detection device 800 allows the camera 862 to observe the root 124 of the internal thread 114 about the perimeter of the hole 112 from the bottom of the hole to the top where the threads cease, maintaining axial alignment at all times.

Various modifications of this detection device are contemplated. For example, the threads 826 of the detection device 800 may be omitted and the free end 806 of the detection device 800 may contact the bottom 120 of the hole 112 with the radial bore 822 being axially aligned with the intersection 118 of the sidewall 122 of the hole 112 with the bottom surface 120. Hence, this critical area may be observed in its entirety by simply rotating the detection device 800. Also, this device may be incorporated into a probe, etc. A side by side arrangement of the camera and light source are shown but it is contemplated that they could be arranged concentrically.

The strength of the magnets discussed herein may range as needed or desired. However, in many applications, a magnetic strength of 30-60 Gauss may be desirable. In yet other applications, any suitable strength of magnet that is sufficient to detect discontinuities may be used. In certain cases, any magnet compliant with ASTM standards E1444M-12 and E0709-08 may be used.

Similarly, any magnetic particle solution or fluid may be used depending on the application. This includes any water or oil based solutions or fluid. In some embodiments, a magnetic particle fluid sold under the TRADENAME of MAGNAFLUX 14A REDI-BATH may be used.

### INDUSTRIAL APPLICABILITY

In practice, a probe, a detection device, and/or an assembly, subassembly or component of either a probe or a detection device according to any embodiment described herein may be sold, manufactured, bought etc. and used to inspect parts at any time whether after initial fabrication or during maintenance intervals, etc. In particular, a method of using the apparatus just described will now be addressed. It should be noted that this method may be used with blind or thru-holes. Similarly, any apparatus described herein such as a probe or a camera, etc., may be used to inspect any kind of hole, including threaded, non-threaded, blind or thru, etc.

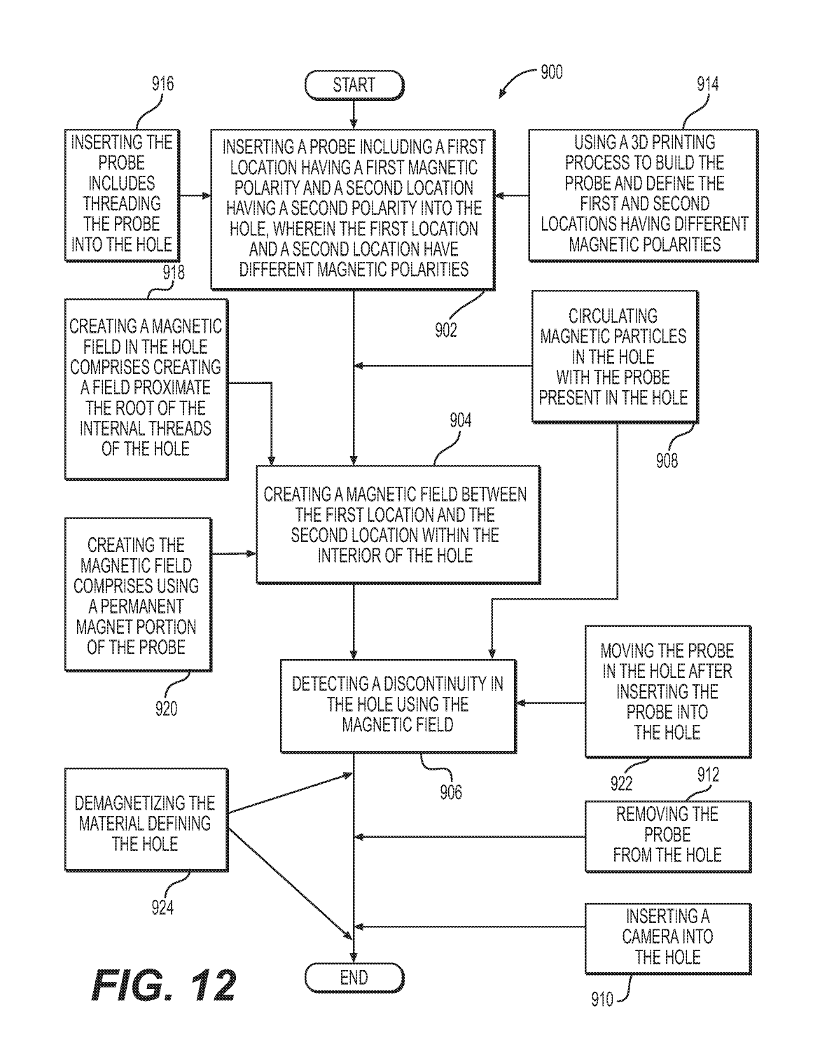

FIG. 12 is a flowchart showing the method of use. The method 900 comprises inserting a probe including a first location having a first magnetic polarity and a second location having a second polarity into the hole, wherein the first location and second location have different magnetic polarities (see step 902), creating a magnetic field between the first location and the second location within the interior of the hole (see step 904), and detecting a discontinuity in the blind hole using the magnetic field (see step 906).

The method may further comprise circulating magnetic particles in the hole with the probe present in the hole (see step 908). Then, the method may comprise inserting a camera into the blind hole (see step 910). The method may further comprise removing the probe from the hole (see step 912).

In some embodiments, the method may comprise using a 3D printing process to build the probe and define the first and second locations having different magnetic polarities (see step 914). In yet other embodiments, the hole is internally threaded and the probe is externally threaded and inserting the probe includes threading the probe into the hole (see step 916).

Creating the magnetic field may include certain sub-steps. For example, creating a magnetic field in the hole may comprise creating a field proximate the root of the internal threads of the hole (see step 918). In other embodiments, creating the magnetic field may comprise using a permanent magnet portion of the probe (see step 920).

Detecting a discontinuity may include certain sub-steps such as moving the probe in the hole after inserting the probe into the hole (see step 922). This may involve moving the probe axially, circumferentially or radially, or any combination of these three directions.

In certain embodiments, it may be desirable to add the step of demagnetizing the material defining the hole (see step 924). In many cases, this may not be necessary as residual magnetism will not be great enough to adversely affect the use of the component after inspection is complete. However, it is contemplated that demagnetization may be accomplished in various ways if so needed or desired. For example, rotation of a permanent DC magnet, reversing the polarity of an AC current magnet, etc. may demagnetize the component.

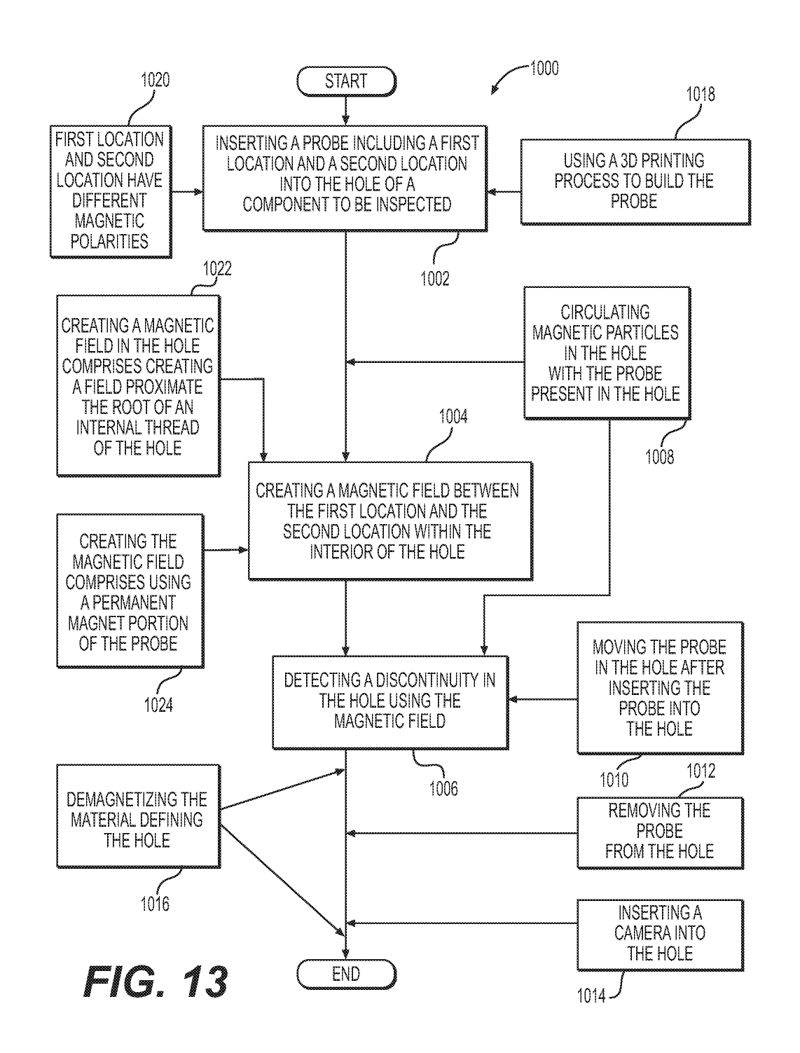

A more general method for using the various embodiments of the apparatus is depicted by FIG. 13. The method 1000 comprises inserting a probe including a first location and a second location into a hole of a component to be inspected (see step 1002). This may include the embodiment of FIG. 10 where a first end and a second end are inserted into the hole creating a magnetic field between the first end and the second end by running current down the probe (see step 1004). Then, a discontinuity may be detected in the hole using the magnetic field (see step 1006). In many embodiments, magnetic particles are circulated in the hole with the probe present in the hole (step 1008). It may be helpful to move the probe in the hole after inserting the probe into the hoe (step 1010).

After the magnetic particles have been circulated, the probe may be removed from the hole (step 1012). In some cases, the camera is then inserted into the hole to look for discontinuities highlighted by the magnetic particles (step 1014). In some cases, the camera may be part of the probe or may be separate from the probe. The material defining the hole may be demagnetized if so needed or desired (step 1016).

Referring more specifically to the embodiments depicted by FIGS. 4-9, the probe may be built using a 3D printing process (step 1018). This may allow the first location and the second location to have different magnetic polarities (see step 1020). Also, a magnetic field may be created proximate the root of an internally threaded hole (step 1022). In some embodiments, the probe has a permanent magnet portion that creates the magnetic field (step 1024).

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A probe for detecting discontinuities at the roots of internal threads, the probe comprising:
an elongated probe portion that defines a longitudinal axis, a radial direction, a circumferential direction and a circumferential surface, wherein the circumferential surface defines an external thread profile including at least a first pitch, and wherein the first pitch defines a first magnetic polarity and a second magnetic polarity that is different than the first magnetic polarity.

2. The probe of claim 1 wherein the probe comprises a plurality of similarly configured pitches having first and second magnetic polarities that are different from each other created using a 3D magnet printing.

3. The probe of claim 2 wherein the first magnetic polarity is north and the second magnetic polarity is south.

4. The probe of claim 1 wherein the external thread profile is a standard thread profile.

5. The probe of claim 1 wherein the elongated probe portion defines an internal void, making the probe portion at least partially hollow.

6. The probe of claim 5 wherein internal void extends to the free end of the probe.

7. The probe of claim 5 wherein the elongated probe portion defines a plurality of apertures extending at least partially radially from the internal void to threaded profile of the circumferential surface.

8. A probe for detecting discontinuities at the bottom of a hole, the probe comprising:
an elongated probe portion that defines a longitudinal axis, a radial direction, a circumferential direction and a circumferential surface;
wherein the elongated probe portion further defines a free end that intersects with the circumferential surface and wherein the elongated portion includes a first location on the free end adjacent the intersection along the longitudinal axis and a second location on the circumferential surface adjacent the intersection along the longitudinal axis; and
wherein the first location defines a first magnetic polarity and the second location defines a second magnetic polarity that is different than the first magnetic polarity.

9. The probe of claim 8 wherein the circumferential surface defines a threaded profile spaced away from the intersection of free end and the circumferential surface along the longitudinal axis.

10. The probe of claim 8 wherein the circumferential surface lacks a threaded profile and the first and second locations defining different magnetic polarities are formed using a 3D magnet printing process.

11. A method for inspecting for discontinuities in a hole, the method comprising:
inserting a probe having a first location and a second location into the hole of a component to be inspected;
creating a magnetic field between the first location and the second location within the interior of the hole; and
detecting a discontinuity in the hole using the magnetic field.

12. The method of claim 11 further comprising circulating magnetic particles in the blind hole with the probe present in the hole.

13. The method of claim 11 further comprising inserting a camera into the hole.

14. The method of claim 11 further comprising removing the probe from the hole.

15. The method of claim 11 further comprising using a 3D printing process to build the probe and define the first and second locations having different magnetic polarities.

16. The method of claim 11 wherein the first location and second location have different magnetic polarities.

17. The method of claim 11 wherein creating a magnetic field in the hole comprises creating a field proximate the root of the internal threads of the hole.

18. The method of claim 11 wherein creating the magnetic field comprises using a permanent magnet portion of the probe.

19. The method of claim 11 wherein detecting a discontinuity includes moving the probe in the hole after inserting the probe into the hole.

20. The method of claim 11 further comprising demagnetizing the material defining the hole.
